(19) United States
(12) Patent Application Publication
(10) Pub. No.: US 2025/0031127 A1
(43) Pub. Date: Jan. 23, 2025

(54) CONTROL APPARATUS, CONTROL SYSTEM, CONTROL METHOD, AND PROGRAM

(71) Applicant: NEC Corporation, Tokyo (JP)

(72) Inventor: Atsuhiro ENDO, Tokyo (JP)

(73) Assignee: NEC Corporation, Tokyo (JP)

(21) Appl. No.: 18/769,513

(22) Filed: Jul. 11, 2024

(30) Foreign Application Priority Data
Jul. 18, 2023 (JP) 2023-116643

(51) Int. Cl. H04W 40/22; H04W 28/20

(52) U.S. Cl. CPC H04W 40/22; H04W 28/20

(57) ABSTRACT

Control apparatus controlling data transfer system including a plurality of wireless relay nodes and a plurality of transmission destination nodes displays, if only one relay node is present as single relay destination in first radio wave coverage area of relay node serving as first relay source, first wireless signal output value and relay node as single relay destination on display. If two or more relay nodes are present as a plurality of relay destinations in first radio wave coverage area, control apparatus displays second wireless signal output value smaller than first wireless signal output value and relay node present in second radio wave coverage area on display. If none of relay nodes are present as relay destination in first radio wave coverage area, control apparatus displays third wireless signal output value larger than first wireless signal output value and relay node present in third radio wave coverage area on display.

### FIELD

### Reference to Related Application

The present invention is based upon and claims the benefit of the priority of Japanese patent application No. 2023-116643, filed on Jul. 18, 2023, the disclosure of which is incorporated herein in its entirety by reference thereto.

The present invention relates to a control apparatus, a control system, a control method, and a program.

### BACKGROUND

The following literatures relate to secure distributed data transfer.

PTL 1 relates to a data transfer system in which transmission data is divided into a plurality of fragment data based on a secret sharing scheme, the fragment data is transmitted to their respective transmission paths, and the fragment data received through these transmission paths is restored to the transmission data based on the secret sharing scheme.

PTL 2 relates to a secret information transmission apparatus or the like that prevents a malicious communication apparatus from intercepting secret information.

PTL 3 relates to a distributed information transfer system that distributes and transfers distributed information to a group of transfer destination nodes through a network while maintaining security and restorability of secret information.

PTL 4 relates to a wireless sensor terminal in a multi-hop wireless sensor network system. The wireless sensor terminal can accurately detect the currently vising area of a mobile node, without being affected by a distribution density of fixed nodes that are present around the mobile node.

PTL 5 relates to a network analysis system that can observe the state of the entire area of a wireless network approximately in real time.

PTL 1: Japanese Patent Kokai Application No. 2018-206345

PTL 2: Japanese Patent Kokai Application No. 2014-155153

PTL 3: Japanese Patent Kokai Application No. 2012-100140

PTL 4: Japanese Patent Kokai Application No. 2010-233011

PTL 5: Japanese Patent Kokai Application No. 2008-153868

### SUMMARY

The following analysis has been made by the present inventors.

As an encryption scheme in which original data is divided into a plurality of encrypted data (shares), a threshold secret sharing scheme is known. In this scheme, original data can be restored by acquiring a certain number of shares, the number being equal to or more than a threshold.

In addition, in secure distributed data transfer, which is a data transfer method based on wireless communication, a single path extending through a plurality of wireless relay nodes is used for transmission of a single share encrypted by the threshold secret sharing scheme, whereby shares can be transmitted safely.

However, in the secure distributed data transfer, if radio wave coverage areas overlap between data transfer paths, that is, if the radio wave coverage area of a wireless relay node on one data transfer path overlaps the radio wave coverage area of a wireless relay node on another data transfer path, shares could be eavesdropped and decrypted between these wireless relay nodes of which the radio wave coverage areas overlap.

Thus, it is necessary to avoid such overlapping of the radio wave coverage areas of wireless relay nodes that are present on different data transfer paths. For example, there is a method in which, in a case where there are wireless relay nodes which is adjacent to another wireless relay node adjacent to a relay node in a data transfer path, all of these wireless relay nodes are not selected for another data transfer path for transmitting different share.

However, depending on the geographical arrangement of wireless relay nodes, a plurality of data transfer paths cannot be set by using a plurality of wireless relay nodes whose radio wave coverage areas do not overlap one another.

It is an object of the present invention to provide a control apparatus, a control system, a control method, and a program that contribute to preventing shares in secure distributed data transfer from being eavesdropped and decrypted and contribute to setting a plurality of data transfer paths extending through a plurality of wireless relay nodes.

According to a first aspect of the present invention, there is provided a control apparatus controlling a data transfer system including a plurality of wireless relay nodes and a plurality of transmission destination nodes, the control apparatus including:
a data input part that receives
designation of a single transmission source node among the plurality of wireless relay nodes, the single transmission source node transmitting a plurality of shares obtained by dividing data based on a threshold secret sharing scheme,
designation of a first transmission destination node and a second transmission destination node among the plurality of transmission destination nodes,
designation of one of the wireless relay nodes, the designated wireless relay node serving as a first relay source that belongs to a first data transfer path that extends through one or more of the wireless relay nodes between the transmission source node and the first transmission destination node,
designation of one of the wireless relay nodes, the designated wireless relay node serving as a second relay source that belongs to a second data transfer path that extends through one or more of the wireless relay nodes between the transmission source node and the second transmission destination node,
designation of a wireless signal output value of the wireless relay node serving as the first relay source, and
designation of a wireless signal output value of the wireless relay node serving as the second relay source; and
a data transfer path setting part that selects, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the designations having been received by the data input part, the wireless relay nodes, to set the wireless signal output values respectively in the selected wireless relay nodes, and sets the first data transfer path and the second data transfer path;
wherein when the data input part receives the designation of the wireless relay node serving as the first relay source or the designation of the wireless relay node serving as the second relay source, the data transfer path setting part
refers to location-related information,
displays, if only one of the wireless relay nodes is present as a single relay destination in a first radio wave coverage area formed when the wireless relay node serving as the first relay source or the wireless relay node serving as the second relay source outputs a wireless signal with a first wireless signal output value, the first wireless signal output value and the wireless relay node as the single relay destination on a display apparatus,
displays, if two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, a second wireless signal output value smaller than the first wireless signal output value and the wireless relay node that is present in a second radio wave coverage area formed when the wireless signal is outputted with the second wireless signal output value on the display apparatus, and
displays, if none of the wireless relay nodes are present as a relay destination in the first radio wave coverage area formed when the wireless relay node serving as the first relay source or the wireless relay node serving as the second relay source outputs the wireless signal with the first wireless signal output value, a third wireless signal output value larger than the first wireless signal output value and the wireless relay node that is present in a third radio wave coverage area formed when the wireless signal is outputted with the third wireless signal output value on the display apparatus.

According to a second aspect of the present invention, there is provided a control system, including:
a data transfer system including a plurality of wireless relay nodes and a plurality of transmission destination nodes;
a display apparatus; and
the control apparatus according to the first aspect that controls the data transfer system.

According to a third aspect of the present invention, there is provided a control method, performed by a control apparatus which controls a data transfer system including a plurality of wireless relay nodes and a plurality of transmission destination nodes, the control apparatus including
a data input part that receives
designation of a single transmission source node among the plurality of wireless relay nodes, the single transmission source node transmitting a plurality of shares obtained by dividing data based on a threshold secret sharing scheme,
designation of a first transmission destination node and a second transmission destination node among the plurality of transmission destination nodes,
designation of one of the wireless relay nodes, the designated wireless relay node serving as a first relay source that belongs to a first data transfer path that extends through one or more of the wireless relay nodes between the transmission source node and the first transmission destination node,
designation of one of the wireless relay nodes, the designated wireless relay node serving as a second relay source that belongs to a second data transfer path that extends through one or more of the wireless relay nodes between the transmission source node and the second transmission destination node,
designation of a wireless signal output value of the wireless relay node serving as the first relay source, and
designation of a wireless signal output value of the wireless relay node serving as the second relay source; and
a data transfer path setting part that selects, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the designations having been received by the data input part, the wireless relay nodes, to set the wireless signal output values respectively in the selected wireless relay nodes, and sets the first data transfer path and the second data transfer path;
wherein when the data input part receives the designation of the wireless relay node serving as the first relay source or the designation of the wireless relay node serving as the second relay source, the data transfer path setting part
refers to location-related information,
displays, if only one of the wireless relay nodes is present as a single relay destination in a first radio wave coverage area formed when the wireless relay node serving as the first relay source or the wireless relay node serving as the second relay source outputs a wireless signal with a first wireless signal output value, the first wireless signal output value and the wireless relay node as the single relay destination on a display apparatus,
displays, if two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, a second wireless signal output value smaller than the first wireless signal output value and the wireless relay node that is present in a second radio wave coverage area formed when the wireless signal is outputted with the second wireless signal output value on the display apparatus, and displays, if none of the wireless relay nodes are present as a relay destination in the first radio wave coverage area formed when the wireless relay node serving as the first relay source or the wireless relay node serving as the second relay source outputs the wireless signal with the first wireless signal output value, a third wireless signal output value larger than the first wireless signal output value and the wireless relay node that is present in a third radio wave coverage area formed when the wireless signal is outputted with the third wireless signal output value on the display apparatus. The present method is associated with a certain machine referred to as a control apparatus (a computer) that executes the control method.

According to a fourth aspect of the present invention, there is provide a program, causing a computer mounted on a control apparatus controlling a data transfer system including a plurality of wireless relay nodes and a plurality of transmission destination nodes to execute:
processing for receiving
designation of a single transmission source node among the plurality of wireless relay nodes, the single transmission source node transmitting a plurality of shares obtained by dividing data based on a threshold secret sharing scheme,
designation of a first transmission destination node and a second transmission destination node among the plurality of transmission destination nodes,
designation of one of the wireless relay nodes, the designated wireless relay node serving as a first relay source that belongs to a first data transfer path that extends through one or more of the wireless relay nodes between the transmission source node and the first transmission destination node,
designation of one of the wireless relay nodes, the designated wireless relay node serving as a second relay source that belongs to a second data transfer path that extends through one or more of the wireless relay nodes between the transmission source node and the second transmission destination node,
designation of a wireless signal output value of the wireless relay node serving as the first relay source, and
designation of a wireless signal output value of the wireless relay node serving as the second relay source;
processing for selecting, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the wireless relay nodes, to set the wireless signal output values respectively in the selected wireless relay nodes, and processing for setting the first data transfer path and the second data transfer path; and
processing for referring to, when the designation of the wireless relay node serving as the first relay source or the designation of the wireless relay node serving as the second relay source is received, location-related information,
processing for displaying, if only one of the wireless relay nodes is present as a single relay destination in a first radio wave coverage area formed when the wireless relay node serving as the first relay source or the wireless relay node serving as the second relay source outputs a wireless signal with a first wireless signal output value, the first wireless signal output value and the wireless relay node as the single relay destination on a display apparatus,
processing for displays, if two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, a second wireless signal output value smaller than the first wireless signal output value and the wireless relay node that is present in a second radio wave coverage area formed when the wireless signal is outputted with the second wireless signal output value on the display apparatus, and
processing for displaying, if none of the wireless relay nodes are present as a relay destination in the first radio wave coverage area formed when the wireless relay node serving as the first relay source or the wireless relay node serving as the second relay source outputs the wireless signal with the first wireless signal output value, a third wireless signal output value larger than the first wireless signal output value and the wireless relay node that is present in a third radio wave coverage area formed when the wireless signal is outputted with the third wireless signal output value on the display apparatus.

This program can be recorded in a computer-readable storage medium. The storage medium may be a non-transitory storage medium such as a semiconductor memory, a hard disk, a magnetic recording medium, or an optical recording medium. The present invention can be embodied as a computer program product.

The present invention can provide a control apparatus, a control system, a control method, and a program that contribute to preventing shares in secure distributed data transfer from being eavesdropped and decrypted and contribute to setting a plurality of data transfer paths extending through a plurality of wireless relay nodes.

### BRIEF DESCRIPTION OF DRAWINGS

FIG. 1 is a diagram illustrating a configuration example of a control system according to an example embodiment of the present invention.

FIG. 2 is a diagram illustrating a configuration example of a control system according to a first example embodiment of the present invention.

FIG. 3 is a diagram illustrating a configuration example of a data transfer system according to the first example embodiment of the present invention.

FIG. 4 is a diagram illustrating an example of location-related information according to the first example embodiment of the present invention.

FIG. 5 is a diagram illustrating an example of a display apparatus displaying an operation example of the control system according to the first example embodiment of the present invention.

FIG. 6 is a diagram illustrating the example of the display apparatus displaying an operation example of the control system according to the first example embodiment of the present invention.

FIG. 7 is a diagram illustrating the example of the display apparatus displaying an operation example of the control system according to the first example embodiment of the present invention.

FIG. 8 is a diagram illustrating the example of the display apparatus displaying an operation example of the control system according to the first example embodiment of the present invention.

FIG. 9 is a diagram illustrating the example of the display apparatus displaying an operation example of the control system according to the first example embodiment of the present invention.

FIG. 10 is a diagram illustrating the example of the display apparatus displaying an operation example of the control system according to the first example embodiment of the present invention.

FIG. 11 is a diagram illustrating the example of the display apparatus displaying an operation example of the control system according to the first example embodiment of the present invention.

FIG. 12 is a diagram illustrating the example of the display apparatus displaying an operation example of the control system according to the first example embodiment of the present invention.

FIG. 13 is a diagram illustrating the example of the display apparatus displaying an operation example of the control system according to the first example embodiment of the present invention.

FIG. 14 is a diagram illustrating a configuration of a computer making up the control apparatus according to the present invention.

### EXAMPLE EMBODIMENTS

First, an outline of an example embodiment of the present invention will be described with reference to a drawing. In the following outline, various components are denoted by reference signs for the sake of convenience. That is, the following reference characters are used only as examples to facilitate understanding of the present invention. Thus, the description of the outline does not limit the present invention to the illustrated mode. An individual connection line between blocks in the drawings, etc., referred to in the following description signifies both one-way and two-way directions. An arrow schematically illustrates a principal signal (data) flow and does not exclude bidirectionality.

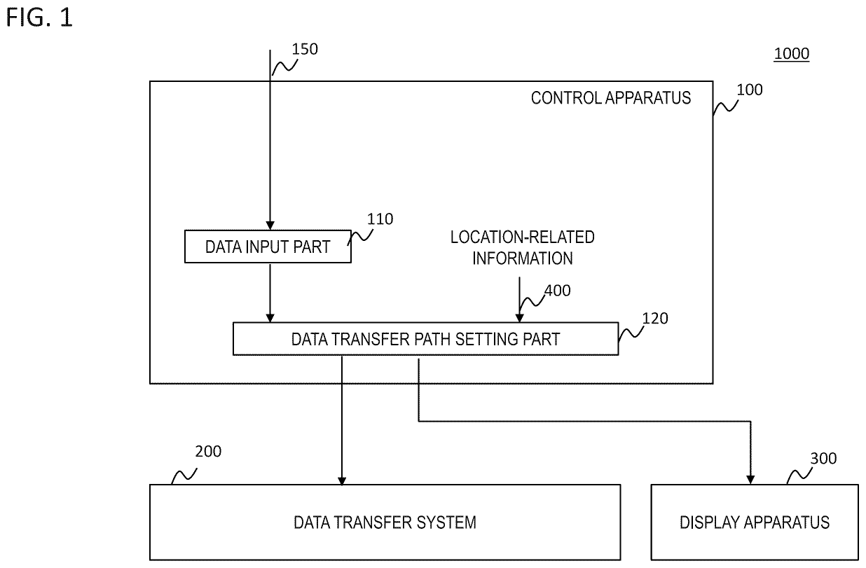

FIG. 1 is a diagram illustrating a configuration example of a control system 1000 according to an example embodiment of the present invention. As illustrated in FIG. 1, the control system 1000 includes a control apparatus 100, a data transfer system 200, and a display apparatus 300. The control apparatus 100 includes a data input part 110 and a data transfer path setting part 120. The data transfer system 200 includes a plurality of transmission destination nodes and a plurality of wireless relay nodes controlled by the control apparatus 100. Displaying on the display apparatus 300 is controlled by the control apparatus 100.

The data input part 110 of the control apparatus 100 receives, from data input 150, designation of a single transmission source node among the plurality of wireless relay nodes, the single transmission source node transmitting a plurality of shares obtained by dividing data based on a threshold secret sharing scheme, designation of a first transmission destination node and a second transmission destination node among the plurality of transmission destination nodes, designation of one of the wireless relay nodes, the designated wireless relay node serving as a first relay source that belongs to a first data transfer path that extends through one or more of the wireless relay nodes between the transmission source node and the first transmission destination node, designation of one of the wireless relay nodes, the designated wireless relay node serving as a second relay source that belongs to a second data transfer path that extends through one or more of the plurality of wireless relay nodes between the transmission source node and the second transmission destination node, designation of a wireless signal output value of the wireless relay node serving as the first relay source, and designation of a wireless signal output value of the wireless relay node serving as the second relay source. All of these designations received by the data input part 110 are sent to the data transfer path setting part 120. The data may be any data. For example, the data may be sensor data.

The data transfer path setting part 120 selects, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the designations having been received by the data input part 110 and having been sent from the data input part 110, the wireless relay nodes, to set the wireless signal output values respectively in the selected wireless relay nodes, and sets the first data transfer path and the second data transfer path.

When the data input part 110 receives the designation of the wireless relay node serving as the first relay source or the designation of the wireless relay node serving as the second relay source, the data transfer path setting part 120 refers to location-related information 400. If only one of the wireless relay nodes is present as a single relay destination in a first radio wave coverage area formed when the wireless relay node serving as the first relay source or the wireless relay node serving as the second relay source outputs a wireless signal with a first wireless signal output value, the data transfer path setting part 120 displays the first wireless signal output value and the wireless relay node as the single relay destination on the display apparatus 300.

When the data input part 110 receives the designation of the wireless relay node serving as the first relay source or the designation of the wireless relay node serving as the second relay source, the data transfer path setting part 120 refers to the location-related information 400. If two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, the data transfer path setting part 120 displays a second wireless signal output value smaller than the first wireless signal output value and the wireless relay node that is present in a second radio wave coverage area formed when the wireless signal is outputted with the second wireless signal output value on the display apparatus. The case in which two or more wireless relay nodes are present as a plurality of relay destinations in the first radio wave coverage area will be referred to as “node congestion state”.

When the data input part 110 receives the designation of the wireless relay node serving as the first relay source or the designation of the wireless relay node serving as the second relay source, the data transfer path setting part 120 refers to the location-related information 400. If none of the wireless relay nodes are present as a relay destination in the first radio wave coverage area formed when the wireless relay node serving as the first relay source or the wireless relay node serving as the second relay source outputs the wireless signal with the first wireless signal output value, the data transfer path setting part 120 displays a third wireless signal output value larger than the first wireless signal output value and the wireless relay node that is present in a third radio wave coverage area formed when the wireless signal is outputted with the third wireless signal output value on the display apparatus 300. The case in which none of the wireless relay nodes are present as a relay destination in the first radio wave coverage area will be referred to as “node sparseness state”.

Via the data input part 110, when the first, second, or third wireless signal output value that the data transfer path setting part 120 displays on the display apparatus 300 is designated as the wireless signal output value of a wireless relay node designated as the first or second relay source, and when a wireless relay node serving as a relay destination is sequentially designated as the wireless relay node as the first or second relay source used next, the data transfer path setting part 120 can designate wireless relay nodes on the first and second data transfer paths and the wireless signal output values of the wireless relay nodes such that the radio wave coverage areas of the wireless relay nodes on the first data transfer path and the radio wave coverage areas of the wireless relay nodes on the second data transfer path will not overlap each other. Thus, it is possible to designate the first and second data transfer paths, that is, a plurality of data transfer paths, which extend through a plurality of wireless relay nodes. The control apparatus 100 can set the first and second data transfer paths in the data transfer system 200, based on the wireless relay nodes designated on the first and second data transfer paths and the wireless signal output values of the wireless relay nodes.

Thus, according to an example embodiment of the present invention, there are provided a control apparatus, a control system, a control method, and a program that contribute to preventing shares in secure distributed data transfer from being eavesdropped and decrypted and contribute to setting a plurality of data transfer paths extending through a plurality of wireless relay nodes.

### First Example Embodiment

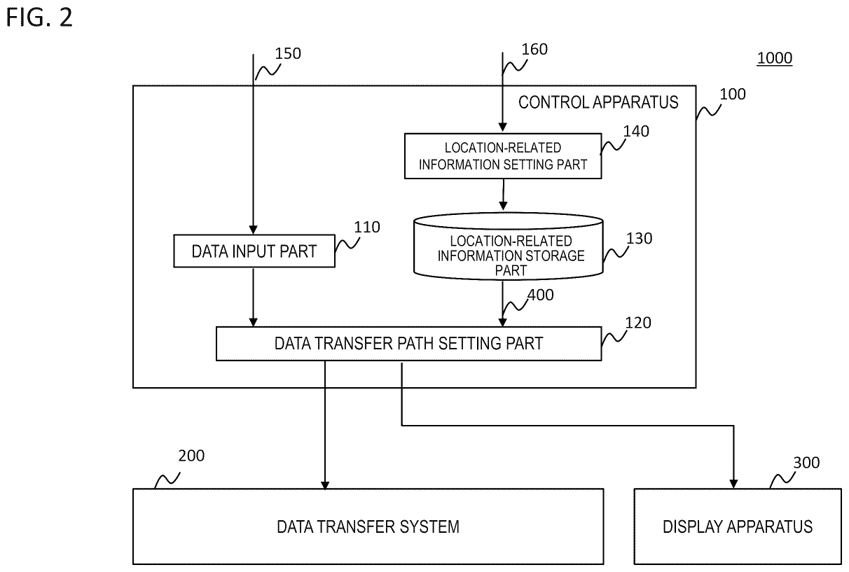

Next, a control system according to a first example embodiment of the present invention will be described with reference to drawings. FIG. 2 is a diagram illustrating a configuration example of a control system 1000 according to the first example embodiment of the present invention. In FIG. 2, the same components as those in FIG. 1 are denoted by the same reference signs.

As illustrated in FIG. 2, the control system 1000 includes a control apparatus 100, a data transfer system 200, and a display apparatus 300. The control apparatus 100 includes a data input part 110, a data transfer path setting part 120, a location-related information storage part 130, and a location-related information setting part 140.

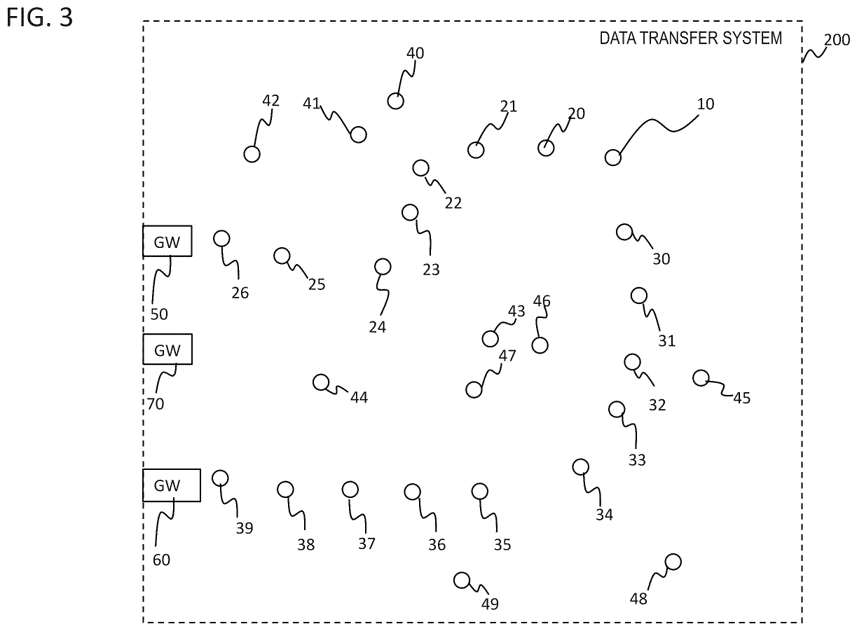

FIG. 3 is a diagram illustrating a configuration example of the data transfer system according to the first example embodiment of the present invention. As illustrated in FIG. 3, the data transfer system 200 includes a plurality of wireless relay nodes 10, 20 to 26, 30 to 39, and 40 to 49, and transmission destination nodes 50, 60, and 70.

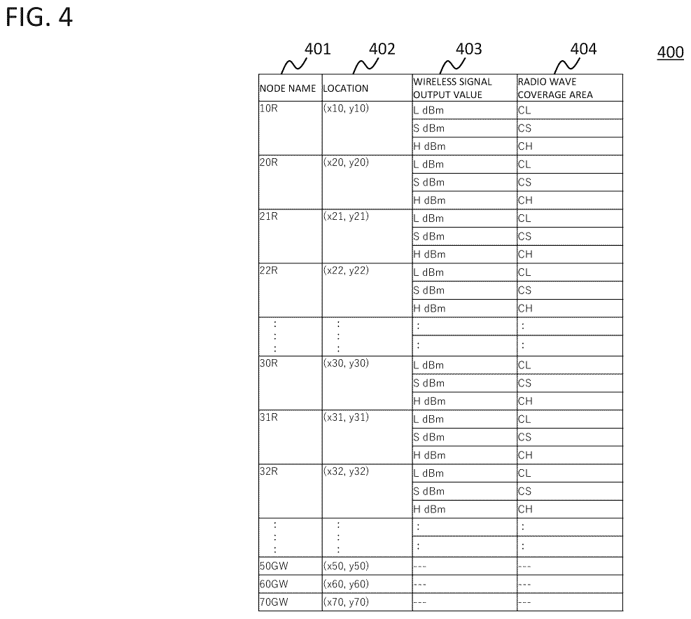

FIG. 4 is a diagram illustrating an example of location-related information according to the first example embodiment of the present invention. As illustrated in FIG. 4, the location-related information 400 includes node names 401, locations 402, wireless signal output values 403, and radio wave coverage areas 404. For example, the individual node name 401 may be expressed by a node number and R representing a wireless relay node, such as 10R or 20R, or may be expressed by a node number and GW representing a gateway as a transmission destination node. For example, the individual location 402 may be expressed by a coordinate (x10, y10) by using a point as the origin.

For example, in the wireless signal output values 403, it is represented that a first wireless signal output value, a second wireless signal output value, and a third wireless signal output value set to the individual wireless relay node are respectively represented as S dBm, L dBm, and H dBm. A radio wave coverage area is indicated as CS when the first wireless signal output value S dBm is set in a wireless relay node. A radio wave coverage area is indicated as CL when the second wireless signal output value L dBm is set in a wireless relay node. A radio wave coverage area is indicated as CH when the third wireless signal output value H dBm is set in a wireless relay node. However, the number of wireless signal output values, the wireless signal output values, the radio wave coverage areas described above are not intended to limit the present invention to the illustrated mode. Because 50GW, 60GW, and 70GW in FIG. 4 denote that the transmission destination nodes 50, 60, and 70 are gateways, no wireless signal output values 403 and no radio wave coverage areas 404 are set because of the transmission destination nodes.

Upon reception of location-related information input 160 via the location-related information setting part 140, the above-described location-related information 400 can be stored from the location-related information setting part 140 in the location-related information storage part 130. By using the location-related information input 160, it is possible to change the location-related information 400 stored in the location-related information storage part 130 or add location-related information 400 in the location-related information storage part 130.

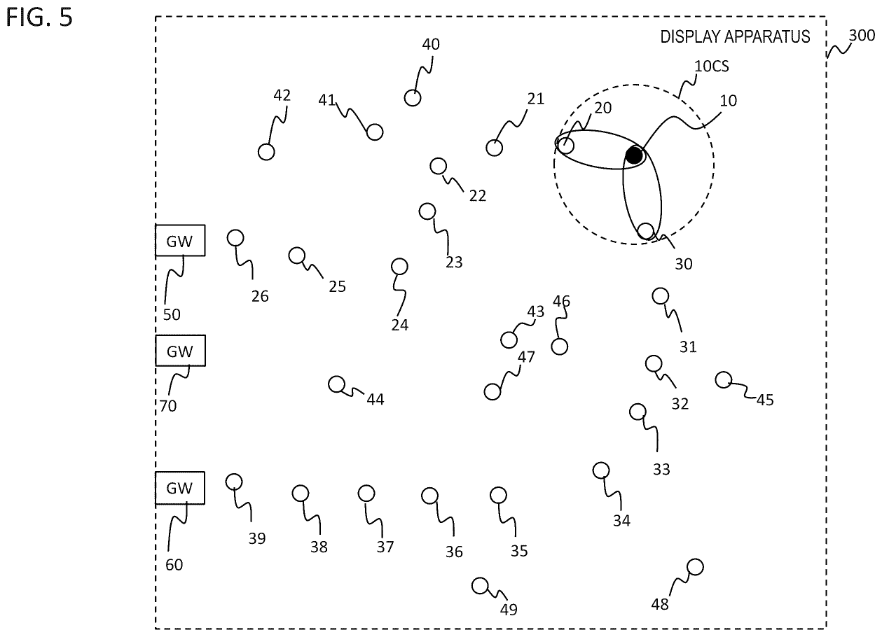

Next, an operation example of the control system 1000 according to the first example embodiment of the present invention will be described. FIGS. 5 to 13 are diagrams illustrating an example of the display apparatus displaying an operation example of the control system according to the first example embodiment of the present invention.

First, for example, a wireless relay node 10, which is included in the data transfer system 200 and which serves as a single transmission source node that transmits a plurality of shares obtained by dividing data based on a threshold secret sharing scheme, is designated via the data input part 110 (the wireless relay node 10 will be hereinafter referred to as “transmission source node 10”). The designation is sent to the data transfer path setting part 120. In addition, for example, the gateway 50 (which will be also referred to as a first transmission destination node 50) serving as a first transmission destination node and the gateway 60 (which will be also referred to as a second transmission destination node 60) serving as a second transmission destination node are designated via the data input part 110. The designations of these gateways 50 and 60 are sent to the data transfer path setting part 120. The data may be any data. For example, the data may be sensor data.

The data transfer path setting part 120 refers to the location-related information 400 stored in the location-related information storage part 130. Next, as illustrated in FIG. 5, the data transfer path setting part 120 displays on the display apparatus 300 that the wireless relay nodes 20 and 30 are included as relay destinations in a radio wave coverage area 10CS formed when the transmission source node 10 outputs the wireless signal output value S dBm. Next, when the wireless signal output value S dBm of the transmission source node 10 is designated via the data input part 110, the designation is sent to the data transfer path setting part 120. The designation of the wireless signal output value S dBm of the transmission source node 10 is the designation of the wireless signal output value of radio waves having directivity to the wireless relay nodes 20 and 30.

According to the first example embodiment of the present invention, it is assumed that a data transfer path extending from the transmission source node 10 to the first transmission destination node 50 via the wireless relay node 20 will be referred to as a first data transfer path, and a data transfer path extending from the transmission source node 10 to the second transmission destination node 60 via the wireless relay node 30 will be referred to as a second data transfer path.

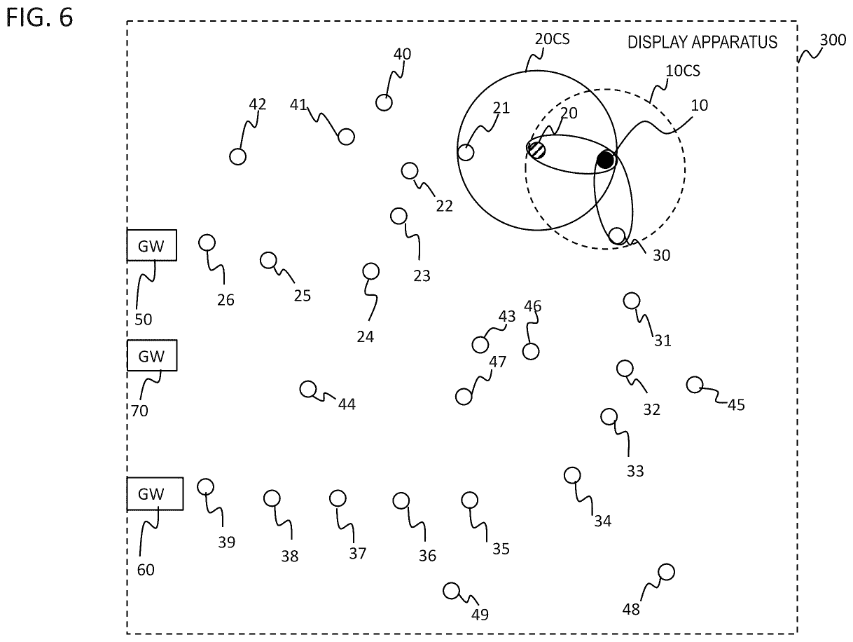

Next, when the wireless relay node 20 is designated as the relay destination node of the transmission source node 10 via the data input part 110, that is, a first relay source node used next (a relay source node that belongs to the first data transfer path will be referred to as a first relay source node, and a relay source node that belongs to the second data transfer path will be referred to as a second relay source node), as illustrated in FIG. 6, the data transfer path setting part 120 refers to the location-related information 400 stored in the location-related information storage part 130. Because the wireless relay node 21 is present as a single relay destination in a first radio wave coverage area 20CS formed when the wireless relay node 20 serving as the first relay source outputs a wireless signal with the first wireless signal output value S dBm, the data transfer path setting part 120 displays the first wireless signal output value S dBm and the wireless relay node 21 as the single relay destination on the display apparatus.

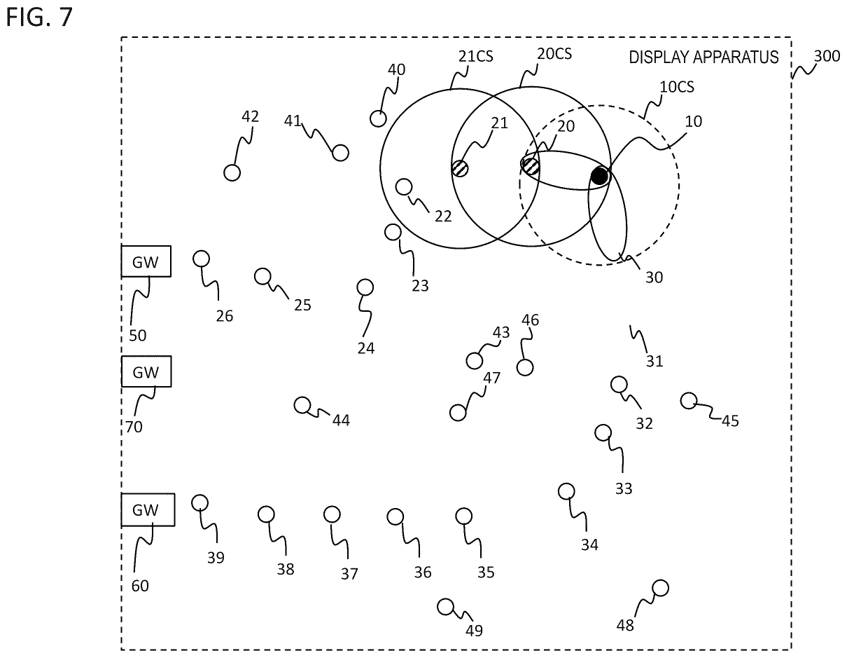

Next, when the wireless relay node 21 is designated as the first relay source node used next via the data input part 110, as illustrated in FIG. 7, the data transfer path setting part 120 refers to the location-related information 400 stored in the location-related information storage part 130. Because the wireless relay node 22 is present as a single relay destination in a first radio wave coverage area 21CS formed when the wireless relay node 21 serving as the first relay source outputs a wireless signal with the first wireless signal output value S dBm, the data transfer path setting part 120 displays the first wireless signal output value S dBm and the wireless relay node 22 as a single relay destination on the display apparatus. Next, when the wireless signal output value S dBm of the wireless relay node 21 is designated via the data input part 110, the designation is sent to the data transfer path setting part 120.

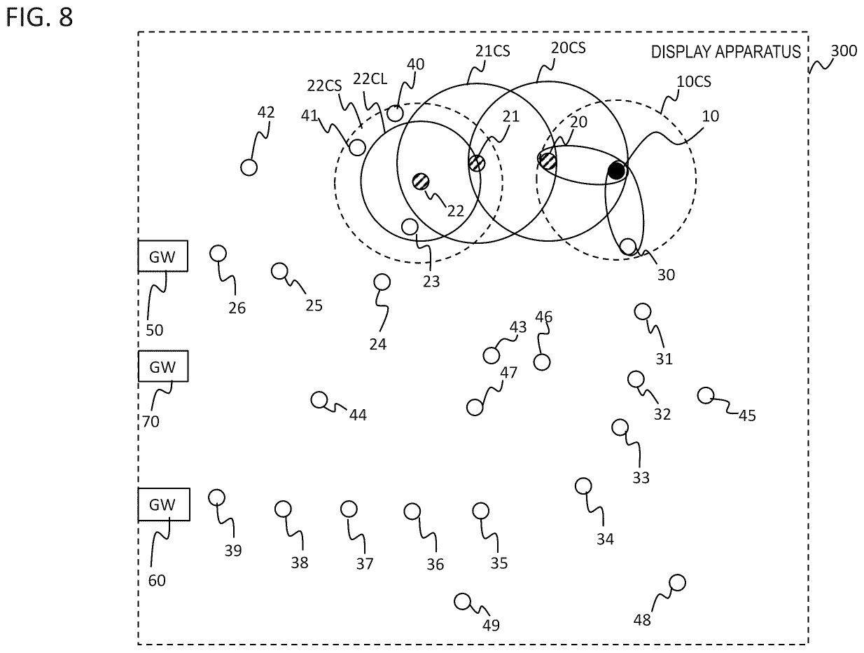

Next, when the wireless relay node 22 is designated as the first relay source node used next via the data input part 110, as illustrated in FIG. 8, the data transfer path setting part 120 refers to the location-related information 400 stored in the location-related information storage part 130. Because the wireless relay nodes 23, 40, and 41 are present as a plurality of (three in the example in FIG. 8) relay destinations in a first radio wave coverage area 22CS formed when the wireless relay node 22 serving as the first relay source outputs a wireless signal with the first wireless signal output value S dBm, the data transfer path setting part 120 displays the second wireless signal output value L dBm smaller than the first wireless signal output value S dBm and the wireless relay node 23 included in a second radio wave coverage area 22CL formed when the wireless signal is outputted with the second wireless signal output value L dBm on the display apparatus. Next, when the wireless signal output value L dBm of the wireless relay node 22 is designated via the data input part 110, the designation is sent to the data transfer path setting part 120.

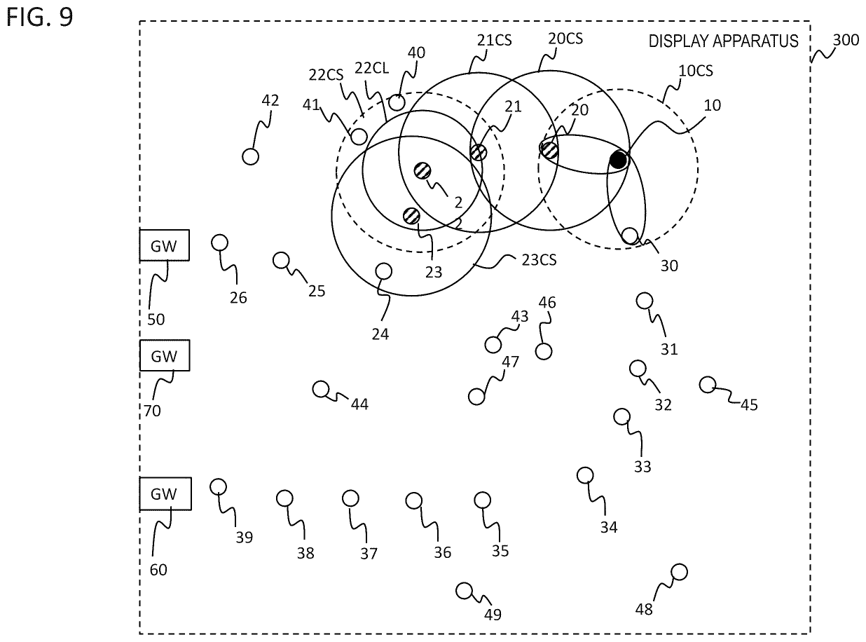

Next, when the wireless relay node 23 is designated as the first relay source node used next via the data input part 110, as illustrated in FIG. 9, the data transfer path setting part 120 refers to the location-related information 400 stored in the location-related information storage part 130. Because the wireless relay node 24 is present as a single relay destination in a first radio wave coverage area 23CS formed when the wireless relay node 23 serving as the first relay source outputs a wireless signal with the first wireless signal output value S dBm, the data transfer path setting part 120 displays the first wireless signal output value S dBm and the wireless relay node 24 as a single relay destination on the display apparatus. Next, the wireless signal output value S dBm of the wireless relay node 23 is designated via the data input part 110.

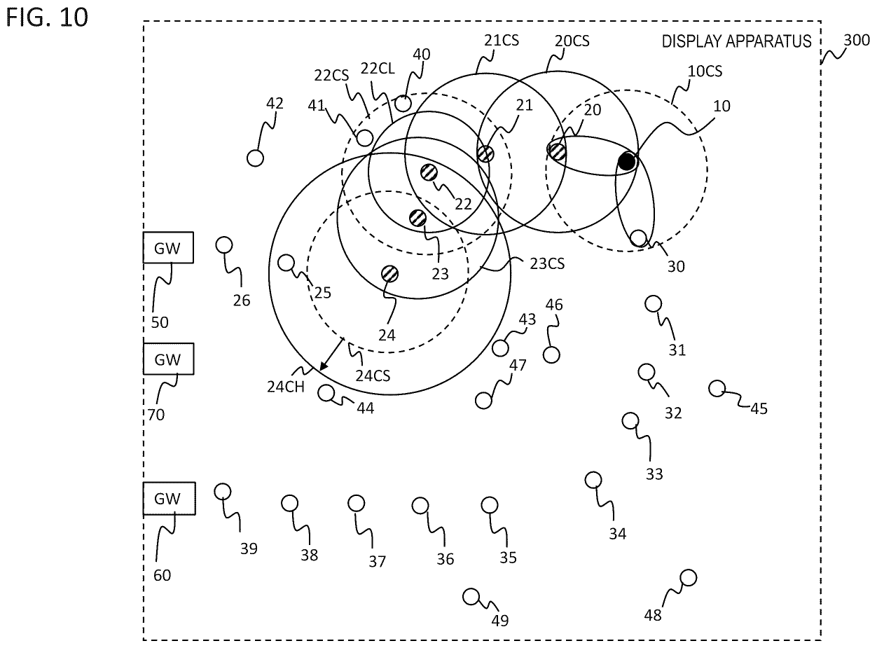

Next, when the wireless relay node 24 is designated as the first relay source node used next via the data input part 110, as illustrated in FIG. 10, the data transfer path setting part 120 refers to the location-related information 400 stored in the location-related information storage part 130. Because none of the wireless relay nodes are present as a relay destination in a first radio wave coverage area 24CS formed when the wireless relay node 24 serving as the first relay source outputs a wireless signal with the first wireless signal output value S dBm, the data transfer path setting part 120 displays the third wireless signal output value H dBm larger than the first wireless signal output value S dBm and the wireless relay node 25 present in a third radio wave coverage area 24CH formed when a wireless signal is outputted with the third wireless signal output value H dBm on the display apparatus. Next, when the wireless signal output value H dBm of the wireless relay node 24 is designated via the data input part 110, the designation is sent to the data transfer path setting part 120.

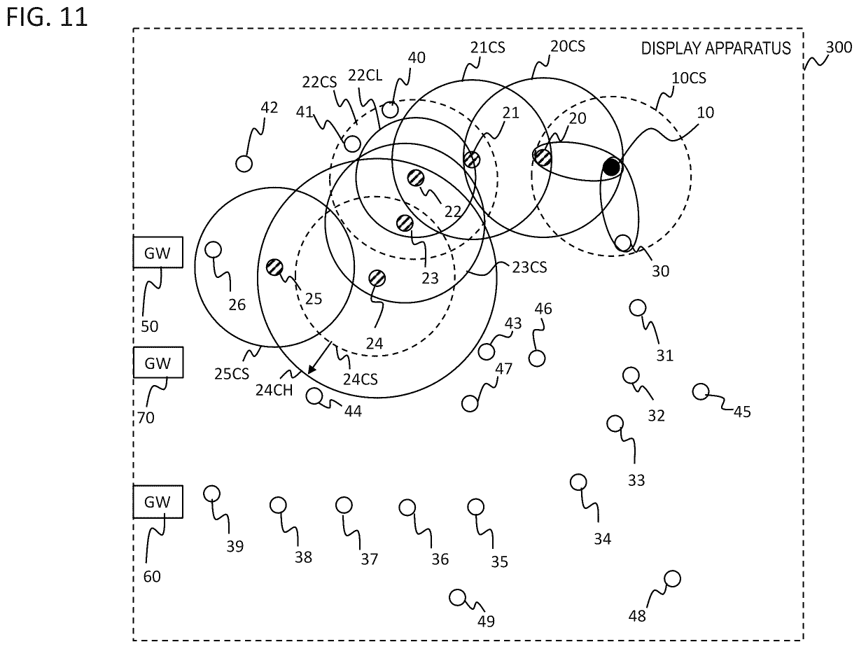

Next, when the wireless relay node 25 is designated as the first relay source node used next via the data input part 110, as illustrated in FIG. 11, the data transfer path setting part 120 refers to the location-related information 400 stored in the location-related information storage part 130. Because the wireless relay node 26 is present as a single relay destination in a first radio wave coverage area 25CS formed when the wireless relay node 25 serving as the first relay source outputs a wireless signal with the first wireless signal output value S dBm, the data transfer path setting part 120 displays the first wireless signal output value S dBm and the wireless relay node 26 as a single relay destination on the display apparatus. Next, when the wireless signal output value S dBm of the wireless relay node 25 is designated via the data input part 110, the designation is sent to the data transfer path setting part 120.

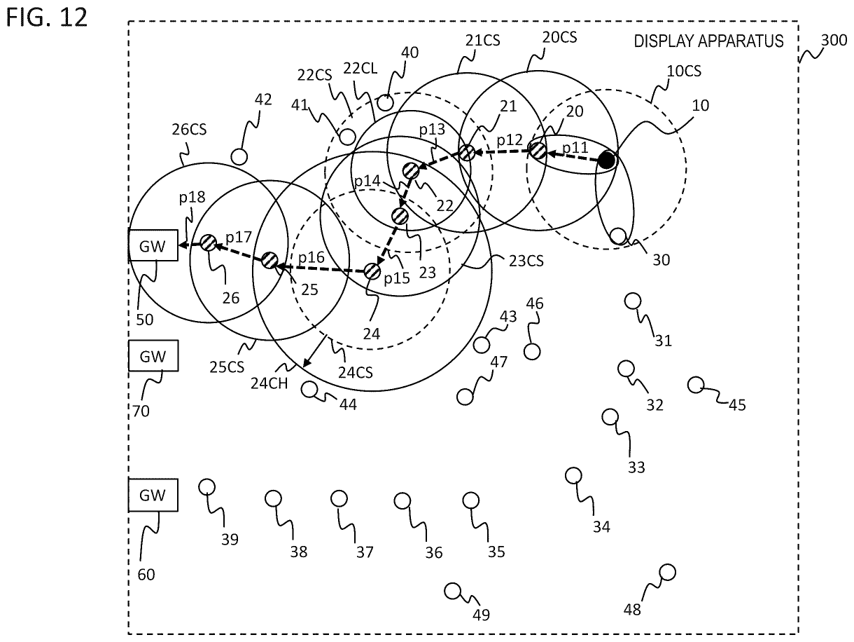

Next, when the wireless relay node 26 is designated as the first relay source node used next via the data input part 110, as illustrated in FIG. 12, the data transfer path setting part 120 refers to the location-related information 400 stored in the location-related information storage part 130. Because the first transmission destination node 50 is present in a first radio wave coverage area 26CS formed when the wireless relay node 26 serving as the first relay source outputs a wireless signal with the first wireless signal output value S dBm, the data transfer path setting part 120 displays the first wireless signal output value S dBm and the first transmission destination node 50 on the display apparatus. Next, when the wireless signal output value S dBm of the wireless relay node 26 is designated via the data input part 110, the data transfer path setting part 120 sets the wireless signal output value S dBm in the wireless relay node 26.

As described above, wireless relay nodes on a first data transfer path are designated, and a wireless signal output values of the wireless relay nodes on the first data transfer path are designated. After the wireless relay nodes on the first data transfer path and the wireless signal output values of the wireless relay nodes on the first data transfer path are designated, as illustrated in FIG. 12, the data transfer path setting part 120 selects the wireless relay nodes 20, 21, 22, 23, 24, 25, and 26, and sets a wireless signal output value (any one of L dBm, S dBm, or H dBm designated as described above) for each of the selected wireless relay nodes 20 to 26. In this way, the data transfer path setting part 120 sets the first data transfer path extending from the transmission source node 10 to the gateway 50 through paths p11, p12, p13, p14, p15, p16, p17, and p18.

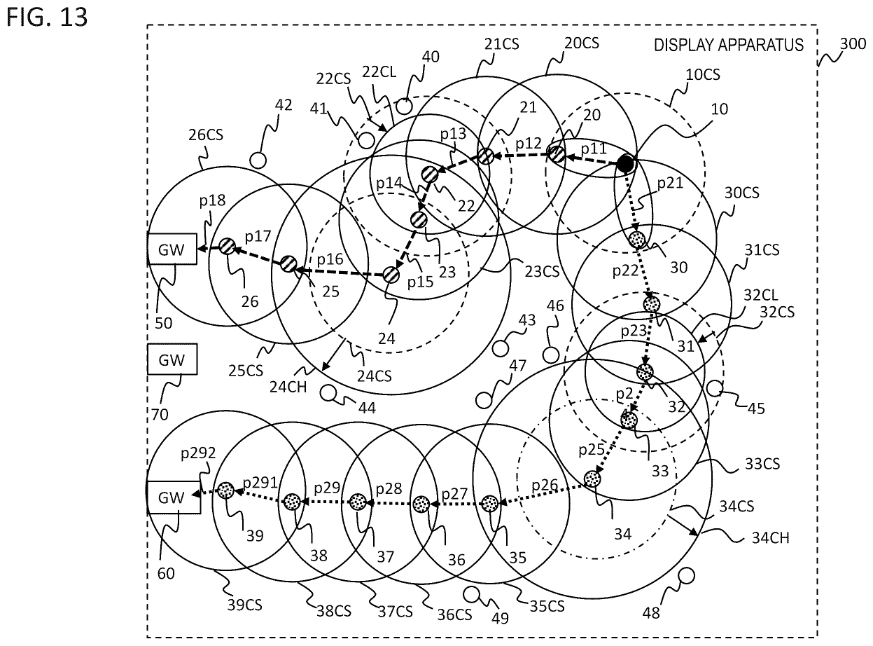

FIG. 13 illustrates not only the first data transfer path illustrated in FIG. 12, but also the second data transfer path, which have been set in the same way as the first data transfer path. The second data transfer path extends from the transmission source node 10 to the gateway 60 via wireless relay nodes 30, 31, 32, 33, 34, 35, 36, 37, 38, and 39 through paths p21, p22, p23, p24, p25, p26, p27, p28, p29, p291, and p292. The control apparatus 100 displays the wireless relay nodes 32 and 34 on the second data transfer path in the same way as the wireless relay nodes 22 and 24 on the first data transfer path, respectively, on the display apparatus 300. The control apparatus 100 displays the other wireless relay nodes 30, 31, 33, and 35 to 39 on the second data transfer path in the same way as the wireless relay nodes 20, 21, 23, 25, and 26 on the first data transfer path on the display After these wireless relay nodes are displayed, the apparatus 300.

wireless signal output values of the wireless relay nodes on the second data transfer path and the individual second relay source node used next are designated via the data input part 110 in the same way as the designation of the wireless signal output values of the wireless relay nodes on the first data transfer path and the designation of the individual first relay source node used next. In this way, the control apparatus 100 sets the second data transfer path illustrated in FIG. 13 in the data transfer system 200.

When the first, second, or third wireless signal output value that the data transfer path setting part 120 displays on the display apparatus 300 is designated via the data input part 110 as the wireless signal output value of a wireless relay node designated as the first or second relay source, and when a wireless relay node serving as a relay destination is sequentially designated as the wireless relay node as the first or second relay source used next, the data transfer path setting part 120 can designate wireless relay nodes on the first and second data transfer paths and the wireless signal output values of the wireless relay nodes such that the radio wave coverage area of the wireless relay node on the first data transfer path and the radio wave coverage area of the wireless relay node on the second data transfer path will not overlap each other. Thus, it is possible to designate the first and second data transfer paths, that is, a plurality of data transfer paths, which extend through a plurality of wireless relay nodes. The control apparatus 100 can set the first and second data transfer paths in the data transfer system 200, based on the transmission source node and the wireless relay nodes on the designated first and second data transfer paths and the wireless signal output values of the wireless relay nodes. The transmission from the transmission source node 10 to the wireless relay nodes 20 and 30 is set based radio waves having directivity.

Thus, according to the first example embodiment of the present invention, there are provided a control apparatus, a control system, a control method, and a program that contribute to preventing shares in secure distributed data transfer from being eavesdropped and decrypted and contribute to setting a plurality of data transfer paths extending through a plurality of wireless relay nodes.

While exemplary embodiments of the present invention have thus been described, the present invention is not limited thereto. Further modifications, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings. In addition, “A and/or B” signifies at least one of A or B.

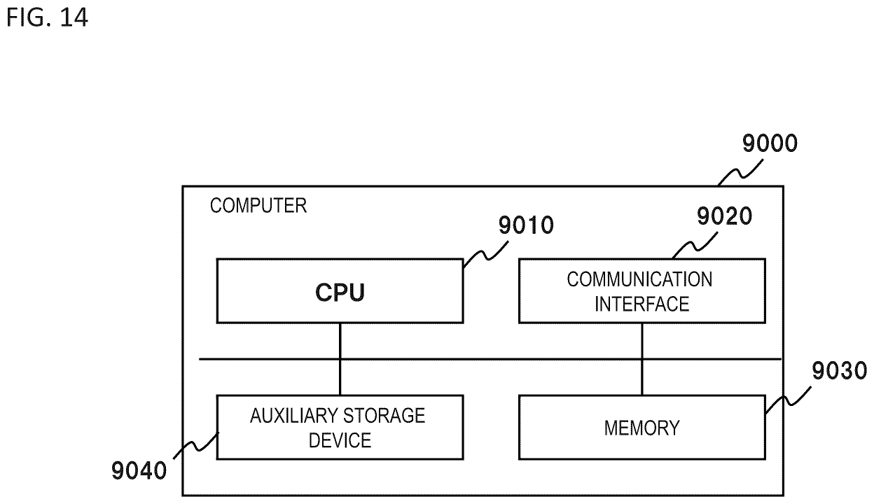

In addition, the procedure according to the above-described first example embodiment can be realized by a program that causes a computer (9000 in FIG. 14) functioning as the control system or the control apparatus according to the present invention to realize the functions of the control system or the control apparatus. This computer has a configuration illustrated as an example in FIG. 14 which includes a central processing unit (CPU) 9010, a communication interface 9020, a memory 9030, and an auxiliary storage device 9040. That is, the CPU 9010 in FIG. 14 executes a control program of the control system or the control apparatus, and executes processing for updating individual calculation parameters stored in the auxiliary storage device 9040 or the like.

The memory 9030 is a random access memory (RAM), a read-only memory (ROM), or the like.

That is, the individual unit (processing means or function) of the control system or the control apparatus according to the above-described first example embodiment can be realized by a computer program that causes a processor of the above-described computer to use corresponding hardware and to execute the corresponding processing described above.

Finally, suitable modes of the present invention will be summarized.

### [Mode 1]

(See the control apparatus according to the above-described first aspect)

### [Mode 2]

The control apparatus according to mode 1; wherein it is preferable that the location-related information include
locations of the wireless relay nodes,
the first wireless signal output value, the second wireless signal output value, and the third wireless signal output value of the wireless relay nodes, the first radio wave coverage area formed when the wireless signal is outputted with the first wireless signal output value, the second radio wave coverage area formed when the wireless signal is outputted with the wireless signal with the second wireless signal output value, the third radio wave coverage area formed when the wireless signal is outputted with the third wireless signal output value, and locations of the plurality of transmission destination nodes.

### [Mode 3]

It is preferable that the control apparatus according to mode 1 or 2 further include a location-related information storage part that stores the location-related information.

### [Mode 4]

It is preferable that the control apparatus according to mode 3 further include a location-related information setting part that sets the location-related information in the location-related information storage part.

### [Mode 5]

The control apparatus according to mode 1; wherein it is preferable that the data transfer path setting part sets the transmission source node such that the transmission source node transmits a wireless signal to the wireless relay nodes by using radio waves having directivity.

### [Mode 6]

The control apparatus according to mode 1; wherein it is preferable that the first data transfer path and the second data transfer path transfer different shares.

### [Mode 7]

(See the control system according to the above-described second aspect)

### [Mode 8]

The control system according to mode 7; wherein it is preferable that the first data transfer path and the second data transfer path transfer different shares.

### [Mode 9]

(See the control method according to the above-described third aspect)

### [Mode 10]

The control method according to mode 9; wherein it is preferable that the first data transfer path and the second data transfer path transfer different shares.

### [Mode 11]

(See the program according to the above-described fourth aspect)

### [Mode 12]

The program according to mode 11; wherein it is preferable that the first data transfer path and the second data transfer path transfer different shares.

Modes 7, 9, and 11 can be expanded in the same way as mode 1 is expanded to modes 3 to 6.

The disclosure of each of the above PTLs is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

10 transmission source node
20 to 26, 30 to 39, 40 to 49 wireless relay nodes
50, 60, 70 transmission destination node
100 control apparatus
110 data input part
120 data transfer path setting part
130 location-related information storage part
140 location-related information setting part
150 data input
160 location-related information input
200 data transfer system
300 display apparatus
400 location-related information
401 node name
402 location
403 wireless signal output value
404 radio wave coverage area
1000 control system
9000 computer
9010 CPU
9020 communication interface
9030 memory
9040 auxiliary storage device

What is claimed is:

1. A control apparatus controlling a data transfer system including a plurality of wireless relay nodes and a plurality of transmission destination nodes, the control apparatus comprising:
at least a processor; and
a memory in circuit communication with the processor,
wherein the processor is configured to execute program instructions stored in the memory to perform:
receiving
designation of a single transmission source node among the plurality of wireless relay nodes, the single transmission source node transmitting a plurality of shares obtained by dividing data based on a threshold secret sharing scheme,
designation of a first transmission destination node and a second transmission destination node among the plurality of transmission destination nodes,
designation of one of the wireless relay nodes, the designated wireless relay node serving as a first relay source that belongs to a first data transfer path that extends through one or more of the wireless relay nodes between the transmission source node and the first transmission destination node,
designation of one of the wireless relay nodes, the designated wireless relay node serving as a second relay source that belongs to a second data transfer path that extends through one or more of the wireless relay nodes between the transmission source node and the second transmission destination node,
designation of a wireless signal output value of the wireless relay node serving as the first relay source, and
designation of a wireless signal output value of the wireless relay node serving as the second relay source; and
selecting, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the designations having been received, the wireless relay nodes, to set the wireless signal output values respectively in the selected wireless relay nodes, and setting the first data transfer path and the second data transfer path;
wherein when the designation of the wireless relay node serving as the first relay source or the designation of the wireless relay node serving as the second relay source is received,
referring to location-related information,
displaying, if only one of the wireless relay nodes is present as a single relay destination in a first radio wave coverage area formed when the wireless relay node serving as the first relay source or the wireless relay node serving as the second relay source outputs a wireless signal with a first wireless signal output value, the first wireless signal output value and the wireless relay node as the single relay destination on a display apparatus,
displaying, if two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, a second wireless signal output value smaller than the first wireless signal output value and the wireless relay node that is present in a second radio wave coverage area formed when the wireless signal is outputted with the second wireless signal output value on the display apparatus, and
displaying, if none of the wireless relay nodes are present as a relay destination in the first radio wave coverage area formed when the wireless relay node serving as the first relay source or the wireless relay node serving as the second relay source outputs the wireless signal with the first wireless signal output value, a third wireless signal output value larger than the first wireless signal output value and the wireless relay node that is present in a third radio wave coverage area formed when the wireless signal is outputted with the third wireless signal output value on the display apparatus.

2. The control apparatus according to claim 1; wherein the location-related information includes
locations of the wireless relay nodes,
the first wireless signal output value, the second wireless signal output value, and the third wireless signal output value of the wireless relay nodes, the first radio wave coverage area formed when the wireless signal is outputted with the first wireless signal output value, the second radio wave coverage area formed when the wireless signal is outputted with the wireless signal with the second wireless signal output value, the third radio wave coverage area formed when the wireless signal is outputted with the third wireless signal output value, and locations of the plurality of transmission destination nodes.

3. The control apparatus according to claim 1, further comprising a location-related information storage part, wherein the processor is configured to execute the program instructions to perform: storing the location-related information to the location-related information storage part.

4. The control apparatus according to claim 3, wherein the processor is configured to execute the program instructions to perform:
setting the location-related information in the location-related information storage part.

5. The control apparatus according to claim 1; wherein the setting comprises setting the transmission source node such that the transmission source node transmits a wireless signal to the wireless relay nodes by using radio waves having directivity.

6. The control apparatus according to claim 1; wherein the first data transfer path and the second data transfer path transfer different shares.

7. A control system, comprising:
a data transfer system including a plurality of wireless relay nodes and a plurality of transmission destination nodes;
a display apparatus; and
the control apparatus according to claim 1 that controls the data transfer system.

8. The control system according to claim 7; wherein the first data transfer path and the second data transfer path transfer different shares.

9. A control method, performed by a computer mounted on a control apparatus which controls a data transfer system including a plurality of wireless relay nodes and a plurality of transmission destination nodes, wherein the computer
receives
designation of a single transmission source node among the plurality of wireless relay nodes, the single transmission source node transmitting a plurality of shares obtained by dividing data based on a threshold secret sharing scheme,
designation of a first transmission destination node and a second transmission destination node among the plurality of transmission destination nodes,
designation of one of the wireless relay nodes, the designated wireless relay node serving as a first relay source that belongs to a first data transfer path that extends through one or more of the wireless relay nodes between the transmission source node and the first transmission destination node,
designation of one of the wireless relay nodes, the designated wireless relay node serving as a second relay source that belongs to a second data transfer path that extends through one or more of the wireless relay nodes between the transmission source node and the second transmission destination node,
designation of a wireless signal output value of the wireless relay node serving as the first relay source, and
designation of a wireless signal output value of the wireless relay node serving as the second relay source; and
the computer selects, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the designations having been received by the computer, the wireless relay nodes, to set the wireless signal output values respectively in the selected wireless relay nodes, and sets the first data transfer path and the second data transfer path;
wherein when the computer receives the designation of the wireless relay node serving as the first relay source or the designation of the wireless relay node serving as the second relay source, the computer
refers to location-related information,
displays, if only one of the wireless relay nodes is present as a single relay destination in a first radio wave coverage area formed when the wireless relay node serving as the first relay source or the wireless relay node serving as the second relay source outputs a wireless signal with a first wireless signal output value, the first wireless signal output value and the wireless relay node as the single relay destination on a display apparatus,
displays, if two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, a second wireless signal output value smaller than the first wireless signal output value and the wireless relay node that is present in a second radio wave coverage area formed when the wireless signal is outputted with the second wireless signal output value on the display apparatus, and
displays, if none of the wireless relay nodes are present as a relay destination in the first radio wave coverage area formed when the wireless relay node serving as the first relay source or the wireless relay node serving as the second relay source outputs the wireless signal with the first wireless signal output value, a third wireless signal output value larger than the first wireless signal output value and the wireless relay node that is present in a third radio wave coverage area formed when the wireless signal is outputted with the third wireless signal output value on the display apparatus.

10. The control method according to claim 9; wherein the location-related information includes
locations of the wireless relay nodes,
the first wireless signal output value, the second wireless signal output value, and the third wireless signal output value of the wireless relay nodes, the first radio wave coverage area formed when the wireless signal is outputted with the first wireless signal output value, the second radio wave coverage area formed when the wireless signal is outputted with the wireless signal with the second wireless signal output value, the third radio wave coverage area formed when the wireless signal is outputted with the third wireless signal output value, and locations of the plurality of transmission destination nodes.

11. The control method according to claim 9, wherein the computer stores the location-related information to a location-related information storage part.

12. The control method according to claim 11, wherein the computer sets the location-related information in the location-related information storage part.

13. The control method according to claim 9; wherein the computer sets the transmission source node such that the transmission source node transmits a wireless signal to the wireless relay nodes by using radio waves having directivity.

14. The control method according to claim 9; wherein the first data transfer path and the second data transfer path transfer different shares.

15. A computer-readable non-transitory recording medium recording a program, the program causing a computer mounted on a control apparatus controlling a data transfer system including a plurality of wireless relay nodes and a plurality of transmission destination nodes to execute:
processing for receiving
designation of a single transmission source node among the plurality of wireless relay nodes, the single transmission source node transmitting a plurality of shares obtained by dividing data based on a threshold secret sharing scheme,
designation of a first transmission destination node and a second transmission destination node among the plurality of transmission destination nodes,
designation of one of the wireless relay nodes, the designated wireless relay node serving as a first relay source that belongs to a first data transfer path that extends through one or more of the wireless relay nodes between the transmission source node and the first transmission destination node,
designation of one of the wireless relay nodes, the designated wireless relay node serving as a second relay source that belongs to a second data transfer path that extends through one or more of the wireless relay nodes between the transmission source node and the second transmission destination node,
designation of a wireless signal output value of the wireless relay node serving as the first relay source, and
designation of a wireless signal output value of the wireless relay node serving as the second relay source;
processing for selecting, in accordance with the designation of the first transmission destination node and the second transmission destination node, the designation of the wireless relay node serving as the first relay source, the designation of the wireless relay node serving as the second relay source, the designation of the wireless signal output value of the wireless relay node serving as the first relay source, and the designation of the wireless signal output value of the wireless relay node serving as the second relay source, the wireless relay nodes, to set the wireless signal output values respectively in the selected wireless relay nodes, and processing for setting the first data transfer path and the second data transfer path; and
processing for referring to, when the designation of the wireless relay node serving as the first relay source or the designation of the wireless relay node serving as the second relay source is received, location-related information,
processing for displaying, if only one of the wireless relay nodes is present as a single relay destination in a first radio wave coverage area formed when the wireless relay node serving as the first relay source or the wireless relay node serving as the second relay source outputs a wireless signal with a first wireless signal output value, the first wireless signal output value and the wireless relay node as the single relay destination on a display apparatus,
processing for displays, if two or more of the wireless relay nodes are present as a plurality of relay destinations in the first radio wave coverage area formed when the wireless relay node serving as the first relay source or the wireless relay node serving as the second relay source outputs the wireless signal with the first wireless signal output value, a second wireless signal output value smaller than the first wireless signal output value and the wireless relay node that is present in a second radio wave coverage area formed when the wireless signal is outputted with the second wireless signal output value on the display apparatus, and
processing for displaying, if none of the wireless relay nodes are present as a relay destination in the first radio wave coverage area formed when the wireless relay node serving as the first relay source or the wireless relay node serving as the second relay source outputs the wireless signal with the first wireless signal output value, a third wireless signal output value larger than the first wireless signal output value and the wireless relay node that is present in a third radio wave coverage area formed when the wireless signal is outputted with the third wireless signal output value on the display apparatus.

16. The medium according to claim 15; wherein the location-related information includes
locations of the wireless relay nodes,
the first wireless signal output value, the second wireless signal output value, and the third wireless signal output value of the wireless relay nodes, the first radio wave coverage area formed when the wireless signal is outputted with the first wireless signal output value, the second radio wave coverage area formed when the wireless signal is outputted with the wireless signal with the second wireless signal output value, the third radio wave coverage area formed when the wireless signal is outputted with the third wireless signal output value, and locations of the plurality of transmission destination nodes.

17. The medium according to claim 15, wherein the program causes the computer to execute: processing for storing the location-related information to a location-related information storage part.

18. The medium according to claim 17, wherein the program causes the computer to execute processing for setting the location-related information in the location-related information storage part.

19. The medium according to claim 15; wherein the program causes the computer to execute processing for setting the transmission source node such that the transmission source node transmits a wireless signal to the wireless relay nodes by using radio waves having directivity.

20. The medium according to claim 15; wherein the first data transfer path and the second data transfer path transfer different shares.
